(19) United States
(12) Patent Application Publication
(10) Pub. No.: US 2017/0030704 A1
(43) Pub. Date: Feb. 2, 2017

(54) Linear Measurement Recorder

(71) Applicant: Yvonne Henderson, Middletown, DE (US)

(72) Inventor: Yvonne Henderson, Middletown, DE (US)

(21) Appl. No.: 15/224,437

(22) Filed: Jul. 29, 2016

Related U.S. Application Data
(60) Provisional application No. 62/198,156, filed on Jul. 29, 2015.

(51) Int. Cl. G01B 11/02

(52) U.S. Cl. CPC G01B 11/02

(57) ABSTRACT

A linear measurement recorder provides a visual display and control buttons on its top surface, and a measurement sensor and rollers on its bottom surface. The recorder is rolled on the floor, along the baseboard next to two adjacent walls, to obtain the length and width of the room. Optionally, a removable, telescoping handle may be provided such that the recorder may be rolled along the baseboard from a standing position. The recorder calculates and displays the floor area of the room, and may be used to measure and store dimensions, and calculate and store floor areas for a plurality of rooms. The recorder may be capable of transferring the stored dimensions and floor areas to another electronic device.

### CROSS-REFERENCE TO RELATED APPLICATIONS

This application claims the benefit of U.S. Provisional Application No. 62/198,156, filed Jul. 29, 2015, which is hereby incorporated by reference.

### STATEMENT REGARDING FEDERALLY SPONSORED RESEARCH OR DEVELOPMENT

Not Applicable

### PARTIES TO A JOINT RESEARCH AGREEMENT

Not Applicable

### REFERENCE TO SEQUENCE LISTING, A TABLE, OR A COMPUTER PROGRAM LISTING COMPACT DISK APPENDIX

Not Applicable

### BACKGROUND OF THE INVENTION

The invention relates generally to measuring devices and in particular to a linear measurement recorder. Realtors, construction and renovation contractors, flooring installers, and many other craftsmen and professionals often face the task of measuring the dimensions of a room and quickly determining the square feet of floor area. The traditional tape measure is available, but is often difficult to use in larger rooms and does not provide calculation or memory functions. Unfortunately, users are often faced with the challenge of accurately measuring rooms and then calculating and recording floor areas as quickly as possible without sacrificing accuracy. A linear measurement recorder, which provides electronic calculation and storage of dimensions and floor areas for an entire house, would resolve this problem.

### SUMMARY OF THE INVENTION

Accordingly, the invention is directed to a linear measurement recorder. The recorder provides a visual display and control buttons on its top surface, and a measurement sensor and rollers on its bottom surface. The recorder is rolled on the floor, along the baseboard next to two adjacent walls, to obtain the length and width of the room. Optionally, a removable, telescoping handle may be provided such that the recorder may be rolled along the baseboard from a standing position. The recorder calculates and displays the floor area of the room, and may be used to measure and store dimensions, and calculate and store floor areas for a large plurality of rooms. The recorder may be capable of transferring the stored dimensions and floor areas to another electronic device.

Additional features and advantages of the invention will be set forth in the description which follows, and will be apparent from the description, or may be learned by practice of the invention. The foregoing general description and the following detailed description are exemplary and explanatory and are intended to provide further explanation of the invention.

### BRIEF DESCRIPTION OF THE DRAWINGS

The accompanying drawings are included to provide a further understanding of the invention and are incorporated into and constitute a part of the specification. They illustrate one embodiment of the invention and, together with the description, serve to explain the principles of the invention.

FIG. 1 is a top view of the first exemplary embodiment, displaying the recorder 10, the visual display 11, the control buttons 12, and the speaker 13.

FIG. 2 is a side view of the first exemplary embodiment, displaying the recorder 10, and the rollers 15.

FIG. 3 is a rear view of the first exemplary embodiment, displaying the recorder 10, the measurement sensor 14, the rollers 15, and the power cord jack 16.

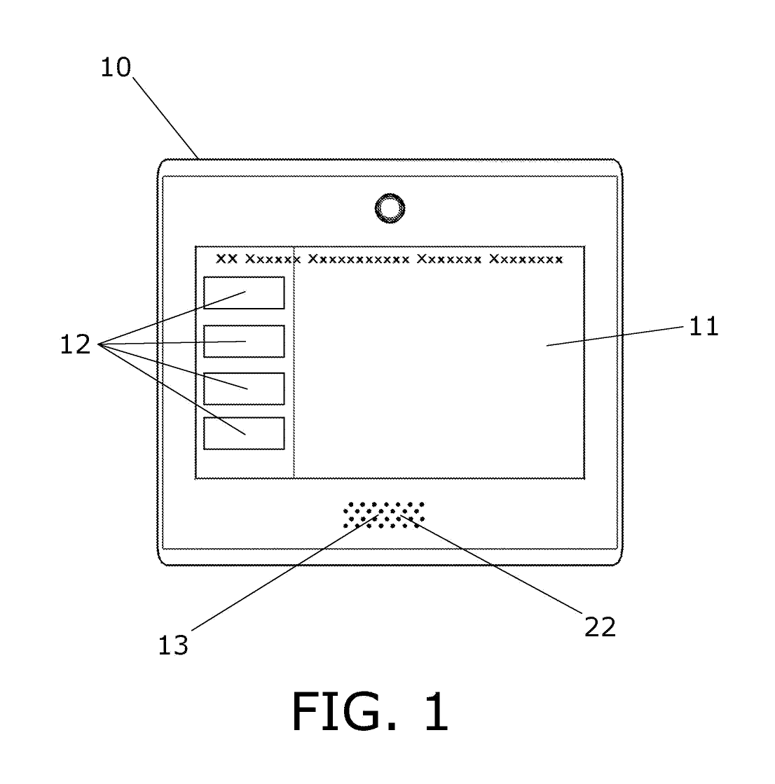

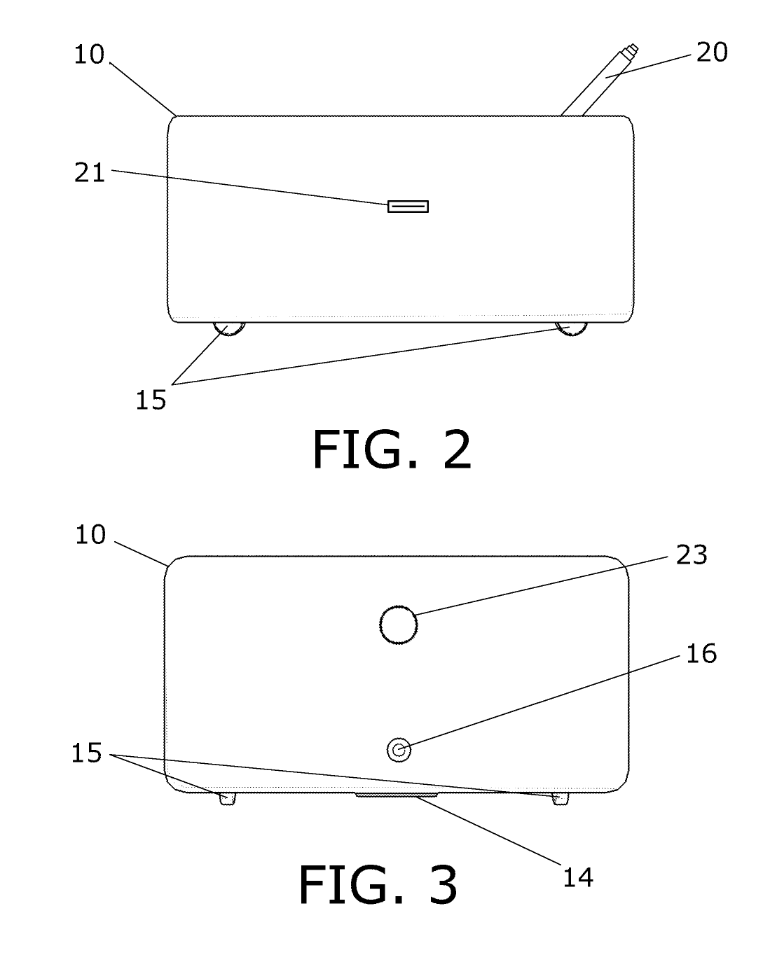

### DETAILED DESCRIPTION OF THE INVENTION

Referring now to the invention in more detail, the invention is directed to a linear measurement recorder 10.

It is to be understood that while the invention is intended to measure the dimensions of one or more rooms, this is not intended as a limitation. With suitable modifications or with no modifications at all, the invention may be used to measure other large objects with flat surfaces such as tables, cabinets, and other furniture.

The first exemplary embodiment is comprised of a rectangular recorder 10 which provides a visual display 11 and control buttons 12 on its front surface, and a measurement sensor 14 and rollers 15 on its bottom surface. The recorder 10 also provides a microprocessor, a memory device, and a rechargeable battery.

The recorder 10 is rolled on the floor of a room, along the baseboard next to two adjacent walls, to obtain the length and width of the room. Optionally, a removable, telescoping handle 20 may be provided such that the recorder 10 may be rolled along the baseboard from a standing position. The recorder 10 uses the microprocessor and memory device to calculate the floor area of the room, and may be used to measure and store dimensions, and calculate and store floor areas for a plurality of rooms. The results are then displayed on the visual display 11.

The recorder 10 may be capable of transferring the stored dimensions and floor areas, in text file or spreadsheet format, to another electronic device, and may provide a Universal Service Bus (USB) port or similar data port 21 for this purpose. A removable power cord is also provided, and may be inserted into the power cord jack 16 of the recorder, then plugged into any standard wall outlet to recharge the battery. The visual display 11 is preferably illuminated with light-emitting diodes (LEDs).

The recorder 10 also provides a small speaker 13 on its front surface, which emits a brief beeping signal when calculations have been completed, and a small microphone 22 and Braille scanning lens 23. The recorder 10 may be operated with voice commands to assist the visually impaired user, by speaking clearly into the microphone, and may also be operated with printed Braille instructions. During the initial set-up of the recorder, the user may select a language to be used for the voice commands, such as English, Spanish, Dutch, or Chinese.

To use the first exemplary embodiment, the user may activate the recorder 10 which is provided, and may roll the recorder 10 on the floor of a room, along the baseboard next to two adjacent walls, to obtain the length and width of the room. These dimensions are then displayed on the visual display 11. The user may then press a control button 12 to calculate the floor area of the room.

The dimensions and floor area are stored on the memory device of the recorder 10 for retrieval. The control buttons 12 may also be used to add the floor areas of selected rooms to calculate a total floor area for a house, apartment, or other multi-room space.

Electronic components of the recorder 10, providing a means for calculating the dimensions of a room, preferably include a memory device, a microprocessor, a rechargeable battery, a visual display 11, control buttons 12, a speaker 13, a microphone 22, a scanning lens 23, and a measurement sensor 14.

The recorder 10 is preferably manufactured from rigid, durable materials such as plastic, steel, aluminum alloy, copper alloy, and brass. The visual display 11 is preferably manufactured from a rigid, durable material which is transparent, such as plastic or malacrylate. The power cord is preferably manufactured from braided copper alloy wire sheathed in plastic.

Components, component sizes, and materials listed above are preferable, but artisans will recognize that alternate components and materials could be selected without altering the scope of the invention.

While the foregoing written description of the invention enables one of ordinary skill to make and use what is presently considered to be the best mode thereof, those of ordinary skill in the art will understand and appreciate the existence of variations, combinations, and equivalents of the specific embodiment, method, and examples herein. The invention should, therefore, not be limited by the above described embodiment, method, and examples, but by all embodiments and methods within the scope and spirit of the invention.

I claim:

1. A linear measurement recorder, comprising:
a. a rectangular recorder;
b. a visual display;
c. said visual display providing at least one control button;
d. a means for storing room dimensions;
e. a measurement sensor being configured to take measurements based on a distance the rectangular recorder has traveled;
f. the means for storing room dimensions being configured to store the measurements of the measurement sensor as room dimensions;
g. a plurality of rollers on a bottom surface of the rectangular recorder;
h. a means for calculating and storing an area of a room;
i. the means for calculating the area of a room being configured to calculate the area of a room based on the measurements taken by the measurement sensor and stored by the means for storing room dimensions; and
j. the visual display being configured to display the room dimensions and the area of the room.

2. The linear measurement recorder of claim 1, wherein said at least one control button is a plurality of control buttons.

3. The linear measurement recorder of claim 1, wherein said measurement sensor is located on the bottom surface of the rectangular recorder, such that the measurements are taken by calculating how much ground has passed beneath the measurement sensor.

4. The linear measurement recorder of claim 1, wherein said visual display is located on a front surface of the rectangular recorder.

5. The linear measurement recorder of claim 1, wherein the dimensions of a room include a length and a width of the room.

6. The linear measurement recorder of claim 5, wherein the area of a room is determined by multiplying the length and the width of the room.

7. The linear measurement recorder of claim 1, further comprising a data port; said data port being configured to transfer the dimensions and area of a room to another device.

8. The linear measurement recorder of claim 7, wherein said data port is a universal service bus port.

9. The linear measurement recorder of claim 1, wherein said visual display is illuminated with light emitting diodes.

10. The linear measurement recorder of claim 1, further comprising a power cord jack; said power cord jack being sized and configured to accept a power cord to provide power to the linear measurement recorder.

11. The linear measurement recorder of claim 1, further comprising a small speaker; said small speaker being located on the front surface; said speaker being configured to make noise when the area of a room has been determined.

12. The linear measurement recorder of claim 1, further comprising a small microphone; said microphone being located on the front surface; said microphone being configured to detect voice commands such that the linear measurement recorder is operated by voice commands.

13. The linear measurement recorder of claim 1, further comprising a scanning lens; said scanning lens being configured to detect visual commands such as printed words such that the linear measurement recorder is operated by visual commands.

14. The linear measurement recorder of claim 1, further comprising a telescoping handle; said telescoping handle being located on the front surface; said telescoping handle extending outwardly from the rectangular recorder.

15. The linear measurement recorder of claim 1, wherein said at least one control button is configured to control the operation of the linear measurement recorder as well as the measurement sensor, means for storing the dimensions of a room and the means for calculating the area of a room.

16. The linear measurement recorder of claim 2, wherein said plurality of control buttons are configured to control the operation of the linear measurement recorder as well as the measurement sensor, means for storing the dimensions of a room and the means for calculating the area of a room.
